(19) United States
(12) Patent Application Publication
(10) Pub. No.: US 2014/0009576 A1
(43) Pub. Date: Jan. 9, 2014

(54) METHOD AND APPARATUS FOR COMPRESSING, ENCODING AND STREAMING GRAPHICS

(71) Applicants: Ilija Hadzic, Millington, NJ (US); Hans Woithe, Dover, DE (US); Martin Carroll, Watchung, NJ (US)

(72) Inventors: Ilija Hadzic, Millington, NJ (US); Hans Woithe, Dover, DE (US); Martin Carroll, Watchung, NJ (US)

(73) Assignee: ALCATEL-LUCENT USA INC., Murray Hill, NJ (US)

(21) Appl. No.: 13/542,142

(22) Filed: Jul. 5, 2012

(51) Int. Cl. H04N 13/00

(52) U.S. Cl. 348/43; 348/E13.064

(57) ABSTRACT

In one embodiment, the method includes receiving at least one tile of a current frame of video data. The method further includes determining whether the tile is a static tile or a dynamic tile based on the current frame and a corresponding tile in an earlier frame. The method further includes partitioning pixels of a static tile into at least one bin, the number of bins being greater than the number of color values that were permitted for the corresponding tile in the earlier frame. The static tile is a tile that has not changed from the earlier frame. The method further includes partitioning pixels of a changed tile into at least one bin, the number of bins being less than the number of color values that were permitted for the corresponding tile in the earlier frame. The changed tile is a tile that has changed from the earlier frame.

### BACKGROUND

Many modern software applications perform three-dimensional (3D) rendering of graphic data. 3D rendering is the process of transforming a model of a 3D scene into a two-dimensional array of pixels. Applications such as computer games and scientific visualization software continuously perform 3D rendering as part of their operation. Additionally, some systems provide a window manager that uses 3D rendering to combine, or composite, windows of individual programs running on the computer into an image representing the computer desktop.

3D rendering involves a series of mathematical operations and typically imposes a significant load on the system. It may be advantageous to perform this rendering in the cloud to allow user devices with limited computing power to take advantage of the processing power of cloud servers to use applications and desktop compositing systems requiring 3D rendering.

In a typical use scenario, a computer desktop is constructed on a server in the cloud, and the desktop undergoes 3D rendering and is streamed to user devices over an Internet Protocol (IP) connection. In order to stream the desktop, the rendered data must be compressed and encoded. However, typical algorithms for compressing and encoding do not account for the variety of applications that may be visualized on a desktop. Typical algorithms may be designed for texture-rich content, such as video games or movies. These algorithms may add unnecessary complexity to the encoding of other desktop elements such as stationary icons, desktop wallpaper, or text. Valuable bandwidth may also be consumed in continuously streaming static or unchanging portions of the screen to the user devices.

### SUMMARY

Embodiments relate to a method and/or apparatus for compressing and encoding 3D-rendered graphic data, and a method and/or apparatus for decoding the encoded 3D-rendered graphic data.

In one embodiment, the method includes receiving at least one tile of a current frame of video data. The method further includes determining whether the tile is a static tile or a dynamic tile based on the current frame and a corresponding tile in an earlier frame. The method further includes partitioning pixels of a static tile into at least one bin, the number of bins being greater than the number of color values that were permitted for the corresponding tile in the earlier frame. The static tile is a tile that has not changed from the earlier frame. The method further includes partitioning pixels of a changed tile into at least one bin, the number of bins being less than the number of color values that were permitted for the corresponding tile in the earlier frame. The changed tile is a tile that has changed from the earlier frame.

In one embodiment, the method further includes generating an encoded tile for the unencoded tile if the tile is a changed tile for which the number of color values is above a minimum threshold. The method further includes generating an encoded tile for the unencoded tile if the tile is a static tile for which the number of color values is below a maximum threshold.

In one embodiment, the method further includes generating an encoded tile for the tile if an acknowledgment indication has not been received, within a time duration after transmission of the tile, for the corresponding tile in the earlier frame.

In one embodiment, the encoded tile includes a color table including color values for each color of the encoded tile and a pixel table including pixel values of the plurality of pixels of the encoded tile, the pixel values being indices into the color table.

In one embodiment, the pixel values are encoded within the pixel table such that least-significant bits of the pixel values for each of the plurality of pixels are encoded in first data words of the pixel table and more-significant bits of the pixel values for each of the plurality of pixels are encoded in second data words.

In one embodiment, the partioning includes determining a mean color value for the at least one bin. The partitioning further includes generating a color table of the pixels of the tile by populating the table with the mean colors of the corresponding bin. The partitioning further includes determining a color index for each pixel of the tile, the color index being an index into the generated color table at which a mean color value of the corresponding bin is stored.

In one embodiment, the partitioning separates the pixels into at least two bins.

In one embodiment, the partitioning separates the pixels into one bin.

In one embodiment, the partitioning further includes, in a subsequent frame, determining that the tile is a static tile. The partitioning further includes partitioning the pixels of the static tile into a greater number of bins relative to a number of bins for the static tile in the previous frame.

In one embodiment, the partioning further includes, in a subsequent frame, determining that the tile is a dynamic tile. The partitioning further includes partitioning the pixels of the dynamic tile into a fewer number of bins relative to a number of bins for the dynamic tile in the previous frame.

In one embodiment, the method includes receiving at least one tile, the tile corresponding to a plurality of pixels of a frame of video data, the tile including a color table and a pixel table. The pixel table includes pixel values of the plurality of pixels of the tile. The pixel values are encoded within the data words of the pixel table such that least-significant bits of the pixel values for each of the plurality of pixels are encoded in first data words of the pixel table and most-significant bits of the pixel values for each of the plurality of pixels are encoded in the second and successive data words. The method further includes constructing at least one frame of the video data based on positional information encoded in the received at least one tile.

In one embodiment, the method further includes transmitting an acknowledgment message for the at least one received tile.

In one embodiment, the transmitting of acknowledgments is based on a control bit encoded in the at least one tile.

In one embodiment, the apparatus includes a processor and an associated memory. The processor is configured to receive at least one tile of a current frame of video data. The processor is further configured to determine whether the tile is a static tile or a dynamic tile based on the current frame and a corresponding tile in an earlier frame. The processor is further configured to partition pixels of a static tile into at least one bin, the number of bins being greater than the number of color values that were permitted for the corresponding tile in the earlier frame. The static tile may be a tile that has not changed from the earlier frame. The processor is further configured to partition pixels of a changed tile into at least one bin, the number of bins being less than the number of color values that were permitted for the corresponding tile in the earlier frame. The changed tile may be a tile that has changed from the earlier frame.

In one embodiment, the processor is further configured to generate an encoded tile for the unencoded tile if the tile is a changed tile for which the number of color values is above a minimum threshold. The processor is further configured to generate an encoded tile for the unencoded tile if the tile is a static tile for which the number of color values is below a maximum threshold.

In one embodiment, the processor is further configured to generate an encoded tile for the tile if an acknowledgment indication has not been received, within a time duration after transmission of the tile, for the corresponding tile in the earlier frame.

In one embodiment, the processor is further configured to determine a mean color value for the at least one bin. The processor is further configured to generate a color table of the pixels of the tile by populating the table with the mean colors of the corresponding bin. The processor is further configured to determine a color index for each pixel of the tile. The color index may be an index into the generated color table at which location the mean color of the corresponding bin is stored.

In one embodiment, the processor is further configured to, in a subsequent frame, determine that the tile is a static tile. The processor is further configured to separate the pixels of the static tile into a greater number of bins relative to a number of bins for the static tile in the previous frame.

In one embodiment, the processor is further configured to, in a subsequent frame, determine that the tile is a dynamic tile. The processor is further configured to separate the pixels of the dynamic tile into a fewer number of bins relative to a number of bins for the dynamic tile in the immediately previous frame.

In one embodiment, the processor includes a processor and an associated memory. The processor is configured to receive at least one tile, the at least one tile corresponding to a plurality of pixels of a frame of video data. The tile includes a color table and a table of pixel values for the pixels of the tile. The pixel values are indexes into the color table. The pixel values are encoded such that least-significant bits of the pixel values for the plurality of pixels are encoded in first data words and more-significant bits of the pixel values for each of the plurality of pixels are encoded in second data words. The processor is further configured to construct at least one frame of the video data based on positional information encoded in the received at least one encoded tile.

The processor is further configured to transmit an acknowledgment message for the at least one received tile.

The processor is further configured to transmit the acknowledgment message based on a control bit encoded in the at least one tile.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 illustrates a system in which example embodiments are implemented;

FIG. 2 illustrates a structure of a processor implementing compressing and encoding according to an embodiment;

FIG. 3 illustrates a structure of a device for receiving compressed and encoded data according to an embodiment;

FIG. 4 illustrates a method for compressing and encoding video data;

FIG. 5 illustrates compression of video data; and

FIG. 6 illustrates an example encoded tile according to at least one example embodiment.

### DETAILED DESCRIPTION OF EXAMPLE EMBODIMENTS

Various embodiments of the present disclosure will now be described more fully with reference to the accompanying drawings. Like elements on the drawings are labeled by like reference numerals.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or” includes any and all combinations of one or more of the associated listed items.

When an element is referred to as being “connected,’ or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Modern personal computers (PCs) often include a graphics processing unit (GPU) whose primary purpose is to relieve the PC's central processing unit (CPU) from computing-intensive tasks related to graphics. Such tasks include, for example, three-dimensional (3D) rendering. 3D rendering is the process of transforming a model of a 3D scene into a two-dimensional array of pixels. These pixels may be displayed on a monitor or stored for further rendering operations. A secondary function of the GPU is to provide an interface to a display device.

As the demands of video and gaming applications require more and more processing power, users have had to continuously upgrade PCs and especially PC GPUs to provide, among other things, increasingly-powerful 3D rendering capability. Users have therefore been motivated to move more and more of their computing activities to the cloud, which provides benefits of sharing and scalability of computing resources.

In moving GPU functionality to the cloud, the GPU's 3D rendering capability may be separated from the GPU's display capability and the two capabilities may be performed at different locations. The 3D rendering capability may be implemented in the cloud on, for example, a server farm, which provides significant processing power. The server farm may connect over a network to the GPU's display functionality running on a user device.

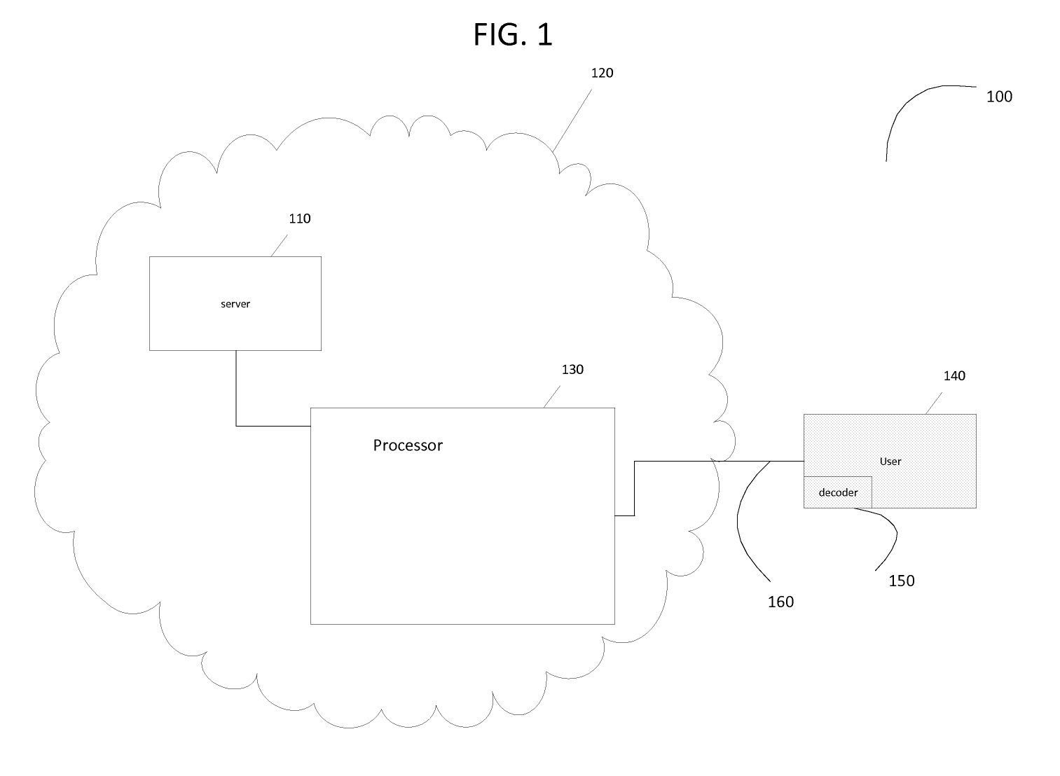

FIG. 1 illustrates a system in which example embodiments are implemented.

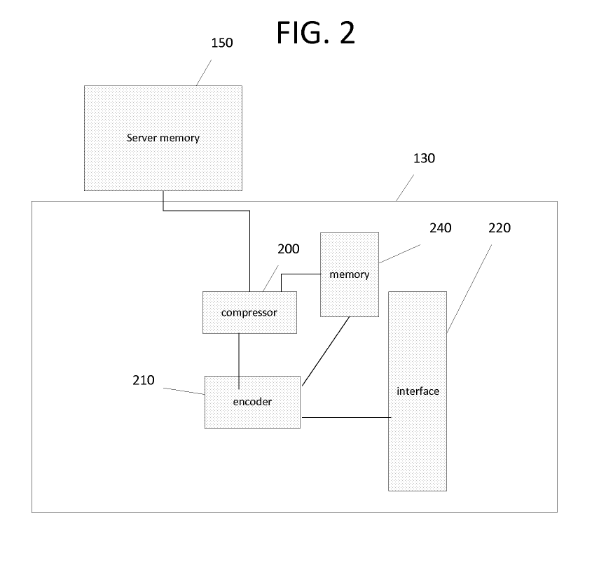

Referring to FIG. 1, a computing system 100 includes at least one server 110. The server 110 stores pixels of rendered frames of video data. The pixels may be stored in a main memory of the at least one server 110 or the pixels may be stored in a dedicated memory of a GPU running on the server. The rendered frames may be frames of, for example, a computer desktop running on a virtual machine in the cloud 120, or the desktop of the server 110, or a window of the desktop of either a virtual machine or the server 110. The pixels of the rendered frames are copied by the server 110 to the processor 130, described below in more detail with respect to FIG. 2.

An example computer desktop running on, for example, a virtual machine in the cloud 120 may have one window running a video game, which has dynamic screen content with highly realistic 3D graphics. The desktop may also have windows with no texture details and very few colors, such as, for example, a DOS command window or UNIX terminal window. Further, the computer desktop may have wallpaper that may be very detailed but that is completely static. The computer desktop may have a task bar at the bottom that is mainly static text.

Conventional video compressing and encoding techniques could be used to compress and encode, for example, a running video game for transmission to user devices. However, video compressing and encoding techniques may add unnecessary complexity when used to compress and encode other, non-video portions of the remote desktop running on, for example, the virtual machine in the cloud 120.

In an example embodiment, a processor 130 provides simplified encoding and data compression of at least the computer desktop running on, for example, the virtual machine in the cloud 120. However, it will be understood that in at least another example embodiment, the processor 130 may provide simplified encoding and data compression for other graphics. Other graphics may include, for example, TV set top box graphics. The processor 130 is described in more detail with respect to FIG. 2.

FIG. 2 illustrates a processor 130 for implementing methods according to at least one embodiment. The processor 130 includes a compressor 200, an encoder 210 and a streaming interface 220. It will be understood, however, that compressor 200, encoder 210 and streaming interface 220 may be implemented on more than one processor 130, and these processors may be tightly-coupled processors.

The compressor 200 receives rendered pixels representing, for example, the desktop of a virtual machine, or other graphics from the server 110. As described previously with respect to FIG. 1, the rendered pixels may be stored in a frame buffer of the main memory of server 110. As a further illustrative example, the rendered pixels may be stored in a dedicated memory of a GPU running on the server 110.

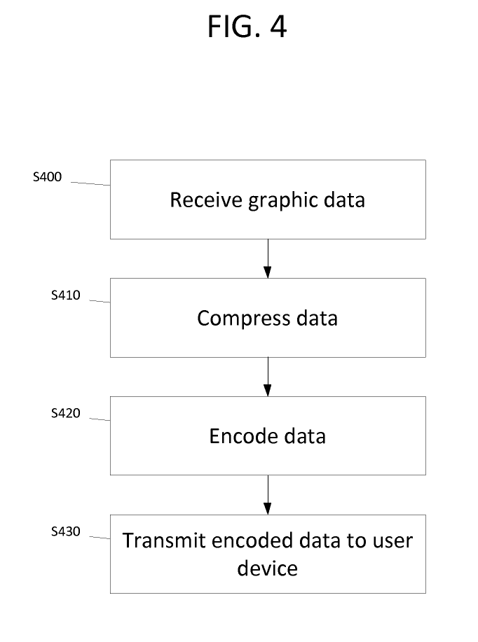

The compressor 200 implements compression algorithms and sends compressed pixels by any known means to an encoder 210. The encoder 210 and compressor 200 may be implemented as software or hardware. The functions of the encoder 210 and the compressor 200 are described in further detail with respect to FIGS. 4-6.

The interface 220 packetizes the encoded pixels for transmission to a user device 140 over the network connection 150.

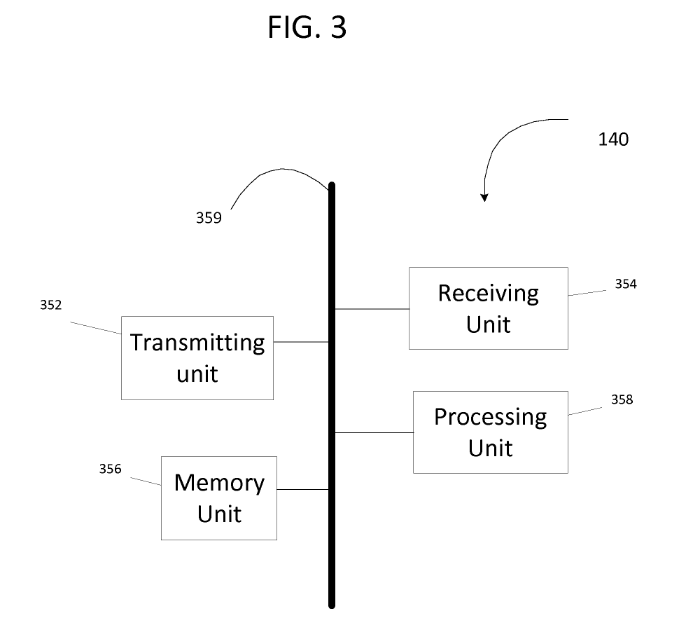

Referring again to FIG. 1, at least one user device 140 is connected to devices in the cloud 120 over the network connection 150. The user device 140 has a corresponding decoder 170 that decodes the data stream received over the network connection 150 and regenerates the original pixels received from the processor 130 according to at least one example embodiment. The user device 140 may provide some further graphics functionality in addition to decoding the data stream and regenerating the pixels received over the network connection 150 from the processor 130. Components of the user device 140 are discussed below with respect to FIG. 3.

FIG. 3 illustrates an example embodiment of the user device 140. It should also be understood that the user device 140 may include features not shown in FIG. 3 and should not be limited to those features that are shown.

Referring to FIG. 3, the user device 140 may include, for example, a data bus 359, a transmitting unit 352, a receiving unit 354, a memory unit 356, and a processing unit 358. The user device 140 may also provide display functionalities.

The transmitting unit 352, receiving unit 354, memory unit 356, and processing unit 358 may send data to and/or receive data from another user device or a network using the data bus 359. The transmitting unit 352 is a device that includes hardware and any necessary software for transmitting wired or wireless signals including, for example, data signals, control signals, and signal strength/quality information via one or more wired or wireless connections to or from, for example, the processor 130.

The receiving unit 354 is a device that includes hardware and any necessary software for receiving wired or wireless signals including, for example, data signals, control signals, and signal strength/quality information via one or more wired or wireless connections to other computers, devices, or, for example, the processor 130.

The memory unit 356 may be any device capable of storing data including magnetic storage, flash storage, etc.

The processing unit 358 may be any device capable of processing data including, for example, a microprocessor configured to carry out specific operations based on input data, or capable of executing instructions included in computer readable code. The computer readable code may be stored on, for example, the memory unit 356. For example, the processing unit 358 is capable of receiving encoded graphical data from the processor 130. The processing unit 358 is further capable of decoding encoded graphical data received from the processor 130.

FIG. 4 illustrates an example embodiment of a method for compressing, encoding and transmitting video data. The video data may represent, for example, desktop graphics for a computer desktop executing on a virtual machine 120.

Referring to FIG. 4, in step S400, the processor 130 receives a pixel stream containing the contents of a frame buffer. In the illustrative example embodiment, these contents were placed in the frame buffer by the window manager described previously. If a user 140 is running an application in full-screen mode, then that application, rather than the window manager, determines the content of the buffer.

### Compression Algorithm

In step S410, the processor 130 compresses this pixel stream data.

Conventional compressional algorithms include, for example, CopyRect encoding. CopyRect encoding is a conventional method used when the screen to be compressed and encoded already contains an identical set of pixels somewhere else.

Another conventional compression algorithm is Tight. Tight analyzes the color histogram of each rectangle and chooses the encoding based on the number of colors. For rectangles with a low number of colors, Tight uses color-indexing to represent pixels. In color-indexing, the color palette is listed in a table and the pixels refer to the table entries instead of to the RGB components of the pixels.

A still further conventional compression algorithm is known as SPEC. In SPEC, the desktop is decomposed into classes and JPEG compression is applied to photorealistic images. For other segments, SPEC analyzes 16×16-pixel tiles, and within each tile SPEC identifies and encodes horizontal and vertical lines (primitives) that represent tile elements. As is known, a tile is a rectangular, typically square, subset of a frame. When a frame is divided into tiles, all tiles are disjoint in that the tiles do not overlap, and the union of all tiles is the entire frame. All tiles of a frame are of the same size.

Yet another conventional compression algorithm is Color Cell Compression (CCC). CCC partitions pixels of a frame into two bins, based on their luminance values, and generates representative color values for each of those bins. CCC additionally generates a bitmap that specifies which pixels belong to which bin.

The compression algorithm, implemented in step S410 according to at least one example embodiment, may be a generalized version of CCC. The processor 130 implements a compression algorithm in step S410 by partitioning a video frame into 8×8-pixel tiles and reducing the number of colors used per tile. The size 8×8 is the tile size most widely-used by GPUs, and hence this size enables improved compression ratios.

In contrast to CCC, the compression algorithm implemented by the processor 130 in an example embodiment allows more than two colors per tile by allowing more than two bins. Further, the compression algorithm implemented by the processor 130 in an example embodiment examines the frame sequence in time. The processor 130 compares each tile of the frame to the corresponding tile in the previous frame. Tiles that are unchanged are determined to be static tiles, while tiles that have changed are determined to be dynamic tiles.

For each static tile, the processor 130 progressively increases the number of colors that may be used for that tile. Conversely, the processor 130 reduces the number of colors for dynamic tiles. In this way, the inventors have discovered, compression may be fast and less complex for dynamic segments of the desktop. While this compression scheme may lead to increased information loss, this information loss is not perceivable by the human eye because of the dynamic nature of those tiles of a desktop. In contrast, static sections of the screen experience increased perceived quality because the number of colors that may be used is increased.

For each tile t of a video frame, the conventional CCC algorithm finds the mean luminance of all pixels that constitute the tile and partitions the pixels into two disjoint subsets. The first subset is the set of pixels whose luminance is less than or equal to the mean luminance and the second subset is the set of pixels whose luminance is greater than the mean luminance. Pixels with the luminance equal to the mean luminance can go into either set, but not both sets, without significantly changing the visual perception of the image. For each subset, the conventional CCC algorithm calculates the mean of all red, green and blue pixel color components and uses this mean color to represent every pixel in the subset. In other words, a tile is mapped to two colors based on the mean luminance.

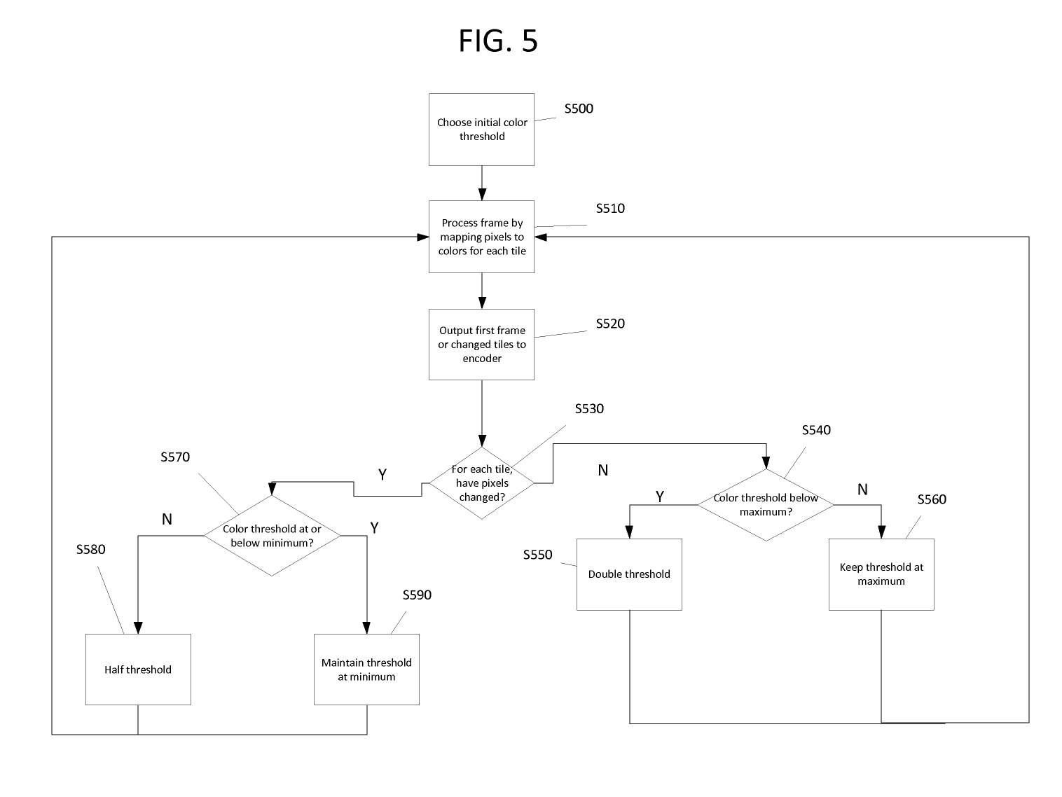

In the compression algorithm implemented by the processor 130 in step S410 according to at least one example embodiment, the CCC concept is generalized by allowing one, two, or more than two colors per tile. The compression algorithm is described in more detail with respect to FIG. 5.

Referring to FIG. 5, in an example embodiment, the processor 130 chooses in step S500 an initial color threshold τₜ=τ₀ for each tile in the first frame. The initial threshold is a configurable parameter of the algorithm and its choice is not critical. A larger initial threshold will make the first few frames sharper in color imaging but the data will not be as compressed and therefore will be larger. However, as described in more detail below, the color threshold will be adjusted for subsequent frames and for each tile.

In step S510, the processor 130 maps pixels of the tiles t to colors. First, for each tile t, the processor 130 uses a color threshold τ where 2≦τₜ≦64 and calculates a function parameter lₜ:

lₜ=log₂ τₜ (1)

It will be understood that while the range 2≦τₜ≦64 may be the most commonly-used range in practice, the range can, in fact, be any value between one and ∞.

The processor 130 then recursively performs a partitioning function to map pixels to colors. The processor 130 maps pixels to colors by first calculating a partitioning vector v(Tₜ,lₜ):

$$v ( T , l ) = \{ \begin{matrix}[ ] & when T = \{ \} , \\ [ {Y}_{i} ] & when T = \{ i \} , \\ [ {m}_{Y} ( T ) ] & when l \leq 1 , \\ [ v ( L , l - 1 ) , {m}_{Y} ( T ) , v ( R , l - 1 ) ] & when l > 1\end{matrix} \qquad ( 2 )$$

where,

L={i|Yᵢ≦m_{Y}(T)}

R={i|Yᵢ>m_{Y}(T)} and

m_{Y}(T) is the mean luminance over the set of pixels T in tile t, defined as:

$${m}_{Y} ( T ) = \frac{1}{\vert T \vert} {\sum }_{i ∈ T} {Y}_{i} \qquad ( 3 )$$

where T is the set of pixels in a tile and Rᵢ, Gᵢ, and Bᵢ are, respectively, red, green, and blue color components of pixel i, and luminance Y is defined according to the known equation:

Yᵢ=0.229Rᵢ+0.587Gᵢ+0.114Bᵢ, iεT (4)

By examining Eq. 2, it will be noted that the partitioning function finds the mean luminance for the whole tile and records the value in the vector v. Then the function partitions the tile into the left and right subsets, L and R, such that the left subset contains all pixels whose luminance is less than or equal to the mean luminance. The right subset contains pixels whose luminance is greater than the mean.

The above-described partitioning step is recursively applied to the left and the right subsets until any of the three specified termination conditions is reached. The mean values recorded in each recursion are the elements of the vector v. Each pixel therefore is mapped into a pixel bin, and therefore to the mean color for its corresponding bin.

As will be noted on examination, for τₜ=2, the two-color conventional CCC partition is obtained and conversely as τₜ→∞ all pixels retain their original luminance. Any chosen threshold value between these extremes will group the pixels of sufficiently similar luminance into the same bins.

After the processor 130 classifies pixels into bins according to the above-described partitioning method, the processor 130 generates the color and pixel tables in the following manner in at least one example embodiment. First, the processor 130 discards all empty bins. Second, the processor 130 enumerates nonempty bins using a sequence of integers, for example O through H−1, where H is the number of bins. The value H is hereinafter referred to as “heat.”

For each nonempty bin (0 through H−1), the processor 130 calculates a single color by averaging the R, G and B components of the pixels in that bin. As an illustrative example, if a bin b has three pixels p0, p1 and p2 whose colors are (R0, G0, B0), (R1, G1, B1), and (R2, G2, B2), then the color associated with the bin by the processor 130 may be expressed as R, G and B components:

Rb=(R0+R1+R2)/3 (5)

Gb=(G0+G1+G2)/3 (6)

Bb=(B0+B1+B2)/3 (7)

The processor 130 therefore has generated a color table, with bin numbers 0 through H−1 associated with bin colors. The processor 130 then constructs a pixel table by mapping, for each pixel p in the tile, p's index within the tile to p's bin number. It will be noted that, rather than representing each pixel with its R, G and B components, the processor 130 in at least one example embodiment represents each pixel with only a bin number, thereby compressing the amount of data used to represent a tile. Because the number of bins for a tile is typically smaller than the number of pixels in the tile, fewer bits are necessary to represent each pixel.

The processor 130 stores the processed frame and the threshold for each tile in memory 240. The processed frame in this context means a frame, the partitioning vector v, the color table for each tile, and the pixel-to-color index mapping for each tile. These two data structures, the processed frame and the threshold, represent the encoder state. It will be noted that this encoder state is relatively small compared to the state of conventional video encoders.

In step S520, the processor 130 outputs the processed frame to the encoder 210, which as described previously may be implemented on the processor 130 or which alternatively may be a separate processor tightly coupled to processor 130.

For subsequent frames, the processor 130 compares the pixels from the current working frame with those from the previously stored frame in step S530. If the tile has not changed, the tile is a stationary or static tile for which sharper color contrasts may be desired. Therefore, the processor 130 checks at step S540 whether the color threshold τₜ for that tile has reached a maximum color threshold, and if not, in at least one example embodiment, the processor doubles the color threshold τₜ in step S550. In at least another example embodiment, the processor 130 does not immediately double the color threshold in the next subsequent frame. Rather, the processor 130 waits for a certain number of frames and, if the tile under consideration has still not changed, the processor 130 then doubles the color threshold. As will be understood and noted by examination of Eq. (1)-(2), doubling the color threshold may cause the pixels to be partitioned more finely into a larger number of bins, if there is a larger number of colors in that tile. Otherwise, in step S460, the processor maintains the threshold at the maximum.

If the tile has changed, the processor 130 first determines whether the color threshold is at a minimum color threshold in step S570. If the color threshold is above the minimum color threshold, the processor 130 halves the color threshold τₜ in step S580. If the color threshold is at or below a minimum color threshold, the processor maintains the color threshold for that tile at the minimum color threshold in step S590. This causes the pixels to be separated into a smaller number of bins resulting in less sharp color for moving tiles and concomitant reduced memory requirements due to increased compression. However, because the human eye cannot discern the moving tiles to the same extent that the human eye can discern stationary tiles, user experience is not worsened.

After the processor 130 adapts the color thresholds for the tiles in steps S540-S590, the processor 130 resumes processing the next frame of pixels using the new thresholds in step S510.

The color threshold minimum τₘᵢₙ and τₘₐₓ are configurable parameters of the compression algorithm that allow the user to trade image quality for compression ratio based on user preferences or requirements. In an example embodiment, the processor 130 may set the maximum and minimum color threshold both to 2, and processing in at least this example embodiment proceeds in the conventional CCC algorithm described previously.

In at least another example embodiment, the processor 130 may set the minimum color threshold to 2 and the maximum color threshold to 64. In at least this example embodiment, static tiles will converge to lossless or near lossless compression. However, bandwidth may still be conserved even in this example embodiment because tiles that do not change over subsequent frames will not be transmitted to the compressor after the maximum color threshold has been reached. Further in at least this example embodiment, changing tiles will converge to the quality of conventional CCC, and therefore the quality of even these tiles will be no worse than conventional quality.

It will be understood that recursive algorithms as those described above may be difficult to implement in hardware and simplifications may be implemented in at least one example embodiment. In at least one example embodiment, the partitioning shown above in Equation (2) is simplified based on equidistant bins between a minimum and maximum luminance:

$$\begin{matrix}v ( T , l ) = [ {min}_{Y} ( T ) + j \frac{{max}_{Y} ( T ) - {min}_{Y} ( T )}{{2}^{l}} , j = 0 … {2}^{l} ] & ( 5 ) \\ where {max}_{Y} ( T ) = {max}_{i ∈ T} {Y}_{i} & ( 6 ) \\ {min}_{Y} ( T ) = {min }_{i ∈ T} {Y}_{i} & ( 7 )\end{matrix}$$

The simplified approximate partitioning function, which may be implemented on hardware in at least one example embodiment, yields sufficiently good results if colors in the tile are evenly distributed and results in higher loss for heavily skewed color distributions within a tile. Nevertheless, it may be visually difficult for the human eye to distinguish the results between the equidistant and original (non-equidistant) partitioning algorithms.

The processor 130 implements compression, described above with respect to example embodiments, in order to enable transporting of a reduced color set for dynamic tiles, while permitting the transporting of full color information for static tiles, to an encoder 210. As described previously, because the human eye cannot necessarily discern color quality in dynamic tiles, sufficient quality can be attained even if a reduced color set is transported for dynamic tiles, and bandwidth may be preserved. On the other hand, compression algorithms implemented by the processor 130 permit transporting of full color information for static tiles, at least because the human eye can discern quality in static tiles to a greater extent.

### Encoding

Referring again to FIG. 4, in step S420, the processor 130 encodes the compressed data. As discussed previously, in an example embodiment, the encoding is implemented in an encoder 210 portion of the processor 130. In at least another example embodiment, the encoding is implemented in a second processor tightly coupled to processor 130. For each tile of the first frame of video data, the compressor 200 portion of processor 130 transports the color table and the pixel color indices, which point into the color table, to the encoder 210 portion of the processor 130.

For subsequent frames after an initial frame of video data, the compressor 200 delivers tiles of only two types to the encoder 210. First, the compressor 200 delivers tiles that have changed from the previous frame to the encoder. Second, the compressor 200 portion delivers tiles that have produced a new color map and pixel indices after a threshold adjustment of step S580 or step S550.

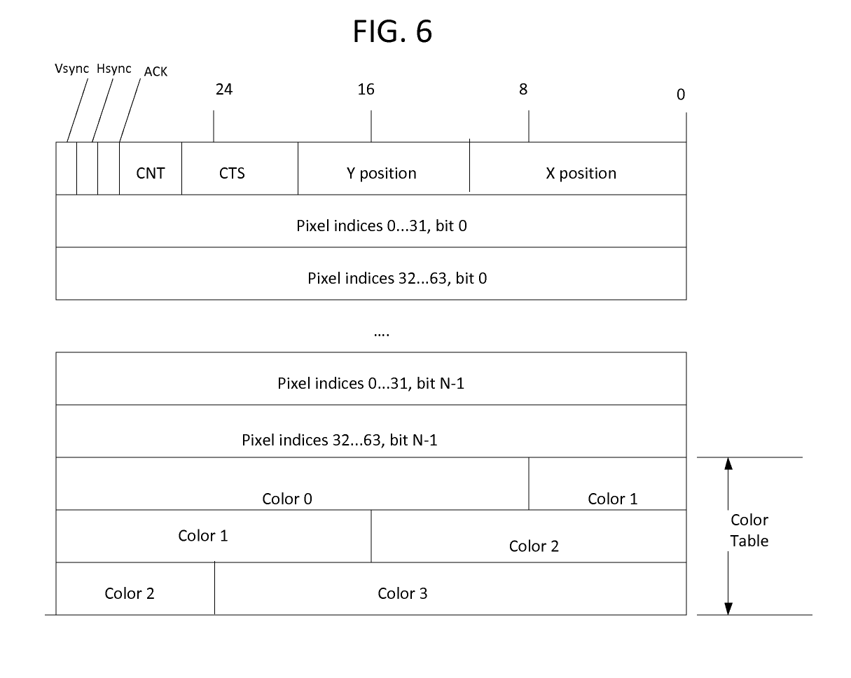

The encoding format, used by the encoder 210 to encode each tile of frame data, is discussed below with reference to FIG. 6.

FIG. 6 depicts the format of an encoded tile according to at least one example embodiment. To encode the tile, the processor 130 may use between 1 and 64 24-bit entries for the color table, one entry per color used in the tile, and between 0 and 6 bits per pixel to encode color indices of the pixels into the color table. The number of colors used in a tile determines the number of 24-bit entries needed for the color table in the encoded tile. The ceiling of the base-2 logarithm of the number of colors in the color table determines the number of bits needed to encode per-pixel color index. Example embodiments may generate single-color tiles.

In addition, the encoded tile includes a control word, which has 32 bits in the example embodiment illustrated in FIG. 6. The control word includes control information, such as, for example, tile coordinates for a tile. The control information may further include a bit for indicating to a user device 140 whether the user device should send an acknowledgment for that tile.

The processor 130 reserves 21 bits for tile coordinates, which includes 11 bits for the x coordinate and 10 bits for the y-coordinate of a tile. The illustrative example embodiment permits resolutions of up to 16384×8192 pixels, which enables the possibility of twice as many pixels in each dimension than the largest known ultra-high definition screen.

In the illustrative embodiment, the processor 130 further uses 6 bits to encode a color table size (CTS), 2 bits for horizontal and vertical synchronization, and 1 bit for whether the server requests an acknowledgment for this tile. A further two bits may be reserved by the processor 130 as a frame counter in order to detect packet loss and enable reordering recovery.

As shown in FIG. 6, the processor 130 may encode a tile such that each tile is self-descriptive by including within the encoding the position of each tile in a frame within the data. Regardless of the transmission packet to which the processor 130 adds any given tile, and regardless of the transmission order of any given tile, the information contained in the encoded tile is sufficient to place pixels at their correct location and in their correct frame.

Dimensions of a frame of video data are not separately transmitted by the processor 130. Instead, the position may be calculated at the decoder using the Hsync and Vsync values. The processor 130 sets a Vsync bit to 1 to indicate that the end of the frame is reached, and the y-position embedded in the encoded tile, when multiplied by 8 and then added to 8, according to at least one example embodiment, indicates the y-dimension of the screen. Similarly, the processor 130 sets the Hsync bit to 1 to indicate the end of a line or row of tiles, and the x-position embedded in the encoded tile, when multiplied by 8 and then added to 8, indicates the x-dimension of the screen in at least one example embodiment. Such implicit coding enables the processor 130 to dynamically resize the screen without additional signaling.

The processor 130 encodes the number of colors Ct used in tile t into the CTS field according to CTS=Ct−1. The number of bits Bt needed to encode each tile is:

Bₜ=32+64┌ log₂ Cₜ┐+24Cₜ (8)

In at least one example embodiment, the processor 130 encodes pixel indices vertically, such that the first 64 bits represent least-significant bits of each pixel of the tile. The following 64 bits carry the values of the next-most-significant bits of all pixels in the tile, and so on. This encoding ensures that the information for pixel p is always at p-th position of a 64-bit word. In contrast to conventional encoding techniques in which complete information for one pixel (all bits of a pixel index) is placed first, vertical encoding ensures that the information for a given pixel is always at the same location in a 64-bit word.

Further in contrast to conventional encoding techniques, vertical encoding of pixel color indices does not require variable bit-wise shifting (e.g., variable shifting depending on the value of CTS) and avoids or helps prevent the possibility of bit-fields that overrun or spill over word-boundaries. This may greatly simplify or make more efficient hardware implementations using a wide data bus.

As an illustrative comparison, one of ordinary skill may consider a hardware implementation of conventional, or horizontal, encoding using a wide data bus, for example a 64-bit data bus. In the illustrative example, a color threshold of 8 is contemplated for an example tile. Three bits would be used by processor 130 to encode such a tile.

Using an illustrative example of a 64-bit bus, three 64-bit words would be required to represent the example tile. In conventional, or horizontal, encoding, the bits of a first pixel, pixel 0, would occupy the first three bits of the first data word; pixel 1 would occupy the second three bits, and so forth. As will be understood, pixel 21 would have one bit in the first data word and then wrap around to take up the first two bits of the second data word. Therefore, at the end of a data word, the bits of a pixel do not align. Pixels can therefore start at any point in a data word. In order to be able to access bits of an arbitrary pixel, it becomes necessary, under horizontal encoding, to be able to shift bits in a data word by an arbitrary number of bits. Further, it is necessary to handle pixels that start in one word and end in a second word. Still further, the shifting cannot be generalized over different implementations if the number of bits per pixels changes in different implementations. Circuit design to handle arbitrary shifting may become complex. Combinatorial networks needed to decode this are large, and larger circuits typically require slower clocks to run the circuit. Further, computer program codes to implement reading of pixel bits may become complicated if it is never known at which position of a word needs to be read or written to in order to access a certain pixel.

In contrast, complexity of circuits and design may be reduced in example embodiments in which the processor 130 encodes compressed tiles using vertical encoding. In the case of vertical encoding, pixels are at the same location in in a data word regardless of the number of bits used to encode each pixel.

The processor 130 may further use vertical encoding to encode the color table in at least one example embodiment. However, in contrast to the pixel color index entries, of which there are always 64 in example embodiments, the color table may have from 1 to 64 entries. If the color table for a given tile only has one entry, then vertical encoding of the color table for that tile will not be an efficient use of memory. For at least this reason, example embodiments need not use a vertical encoding for the color table. Rather, the processor 130 encodes the 24-bit entries of the color table using straightforward packing of the 24-bit entries of the color table.

### Transmission and Decoding

Referring again to FIG. 4, the processor 130 transmits encoded data to the user device in step S430.

Example embodiments implement a transmission protocol to further realize efficiencies granted by compression and encoding of video data according to the above-described example embodiments.

At least because an encoded tile, as depicted in FIG. 6, is self-identifying, a user device 140 may decode and display a tile without additional information. A user device 140 may therefore decode a tile any time after the user device 140 has received a tile.

As is known, Transport Control Protocol (TCP) is a reliable socket-based network transport protocol that keeps lost packets in a buffer and retransmits them until they are received or acknowledged as received by a user device. TCP enforces ordering, such that if a message is transmitted before another message, the first message is guaranteed to be delivered first.

However, such a loss recovery and ordering mechanism may be somewhat inflexible. Therefore, example embodiments may transmit using the Universal Datagram Protocol (UDP) rather than TCP. As is known, UDP does not guarantee packet delivery with loss recovery mechanisms and UDP does not enforce ordering. Example embodiments then further implement alternate loss recovery mechanisms over standard UDP.

In example embodiments, the processor 130 may group multiple tiles together in one UDP packet. However, a UDP packet must contain an integral number of tiles. Stated differently, an encoded tile may not cross a packet boundary. Loss of a UDP packet results in a loss of all tiles in that packet. However, there is no error-propagation into subsequent packets. Out-of-order packet delivery affects only the order in which pixels are put into the frame buffer, but as long as tiles arrive at the user 140 before the scanout deadline, the user display and user experience will not be affected. At least because example embodiments do not rely on a strict ordering of tiles in the compression and encoding steps, the choice and design of transmission protocol may flexibly not require acknowledgments of packets before further packets are sent.

In at least one example embodiment, the user device 140 receives the tiles. The user device 140 acknowledges that the user device 140 has received each tile, if the code word for the tile indicates that an acknowledgment is required. For example, the processor 130 may transmit a tile to the user device 140 if the color threshold for the tile is below a maximum color threshold, regardless of whether the corresponding tile in the previous frame was acknowledged, and for at least this reason bandwidth may be wasted if the user device 140 were to transmit an unnecessary acknowledgment that will be ignored by the processor 130. Therefore, the processor 130 may encode a tile such that the control word indicates that the user device 130 should not transmit an acknowledgment for that tile.

In further example embodiments, increasing a color threshold may not increase the resolution of the tile. As an illustrative example, a tile that only has 32 colors will not see an increased resolution if the threshold is doubled to 64. The actual number of colors used by the encoded tile is less than or equal to the color threshold and is referred to as the tile's heat. If the heat has not changed, the processor 130 may ask for an acknowledgment from the user device 140 and increase the color threshold in one example embodiment. In a further example embodiment, the processor 130 may set the color threshold to a maximum color threshold for that tile.

The processor 130 maintains a map of unacknowledged tiles. The processor 130 starts a timer after the transmission of each frame of tiles. The timer may be set to expire at a duration at least as large as a predicted round-trip propagation time between the processor 130 and the user device 140. In at least one example embodiment, the predicted round-trip time is updated and adjusted based on a measured round-trip time for a tile to be sent and then acknowledged. After the timer expires, the processor 130 checks which tiles have not been acknowledged and marks only those tiles as unacknowledged. In the next frame, the processor 130 transmits changed, refined, and unacknowledged tiles.

If the processor 130 resets for any reason, including for example during a system crash or reboot, the processor 130 maps each tile as unacknowledged and the processor 130 re-transmits each tile of the next frame. If the user device 140 restarts in a way that the user device 140 frame buffer remains preserved, as for example in a warm reboot, the processor 130 will retransmit those tiles until the user device 140 resumes acknowledgment of tiles. If the user device 140 experiences a cold reboot or power cycle that clears the memory, the processor 130 cancels all acknowledgments and retransmits all tiles.

In an example embodiment, as described above regarding the compression algorithm, the processor 130 transmits the first frame of any graphics video. Subsequently, the processor 130 transmits tiles that have changed and tiles that have been refined in resolution because the color threshold has been halved or doubled according to the compression algorithm described above with regard to FIGS. 3 and 4. Further, the processor 130 re-transmits tiles that were not acknowledged by the user device 130. Example embodiments, therefore, may more efficiently use bandwidth by transmitting a limited number of tiles rather than transmitting every tile of every frame. Example embodiments may use bandwidth more efficiently, further, by transmitting more than one tile in a single packet.

Example embodiments do not require that a compressor receive all tiles of a frame in order to begin the compressing process. Rather, the compressor 200 may compress a tile as it is received from the GPU. Per-tile processing enables a compressor to access the data from GPUs that use native-tiled frame buffers, because each tile maps to a continuous address range, which allows fast retrieval using burst read operations of the memory and of the I/O bus of the GPU. At least because example embodiments implement per-tile compressing of graphics data, example embodiments may be implemented on highly parallel architectures such as FPGAs, multi-core processors, or on the GPUs themselves.

Example embodiments do not require that an encoder receive all tiles of a frame in order to begin the encoding process. Rather, the encoder 210 may encode each tile as it is received from the compressor 200 portion of the processor 130. At least because example embodiments implement per-tile encoding of compressed graphics data, example embodiments may be implemented on highly parallel architectures such as FPGAs, multi-core processors, or on the GPUs themselves

Variations of the example embodiments are not to be regarded as a departure from the spirit and scope of the example embodiments, and all such variations as would be apparent to one skilled in the art are intended to be included within the scope of this disclosure.

What is claimed:

1. A method comprising:
receiving at least one tile of a current frame of video data;
determining whether the tile is a static tile or a dynamic tile based on the current frame and a corresponding tile in an earlier frame;
partitioning pixels of a static tile into at least one bin, the number of bins being greater than the number of color values that were permitted for the corresponding tile in the earlier frame, the static tile being a tile that has not changed from the earlier frame;
partitioning pixels of a changed tile into at least one bin, the number of bins being less than the number of color values that were permitted for the corresponding tile in the earlier frame, the changed tile being a tile that has changed from the earlier frame.

2. The method of claim 1, further comprising:
generating an encoded tile for the tile if the tile is a changed tile for which the number of color values is above a minimum threshold; and
generating an encoded tile for the tile if the tile is a static tile for which the number of color values is below a maximum threshold.

3. The method of claim 2, further comprising:
generating an encoded tile for the tile if an acknowledgment indication has not been received within a time duration after transmission of the tile for the corresponding tile in the earlier frame.

4. The method of claim 2, wherein the encoded tile includes
a color table including color values for each color of the encoded tile, and
a pixel table containing the pixel values of the plurality of pixels of the encoded tile, the pixel values being indices into the color table.

5. The method of claim 4, wherein the pixel values are encoded within the pixel table such that least-significant bits of the pixel values for each of the plurality of pixels are encoded in first data words in the pixel table and more-significant bits of the pixel values for each of the plurality of pixels are encoded in second data words.

6. The method of claim 1, wherein the partitioning comprises:
determining a mean color value for the at least one bin;
generating a color table of the pixels of the tile by populating the table with the mean colors of the corresponding bin; and
determining a color index for each pixel of the tile, the color index being an index into the generated color table at which a mean color value of the corresponding bin is stored.

7. The method of claim 6, wherein the partitioning separates the pixels into at least two bins.

8. The method of claim 6, wherein the partitioning separates the pixels into one bin.

9. The method of claim 6, wherein the partitioning further comprises:
in a subsequent frame, determining that the tile is a static tile;
partitioning the pixels of the static tile into a greater number of bins relative to a number of bins for the static tile in the previous frame.

10. The method of claim 6, wherein the partitioning further comprises:
in a subsequent frame, determining that the tile is a dynamic tile;
partitioning the pixels of the dynamic tile into a fewer number of bins relative to a number of bins for the dynamic tile in the previous frame.

11. A method comprising:
receiving at least one tile, the tile corresponding to a plurality of pixels of a frame of video data, the tile including a color table and a table of pixel values for the pixels of the tile, the pixel values being indexes into the color table, and the pixel values encoded such that least-significant bits of the pixel values for the plurality of pixels are encoded in the first data words and the more-significant bits of the pixel values of the plurality of pixels are encoded in second data words; and
constructing at least one frame of the video data based on positional information encoded in the received at least one tile.

12. The method of claim 11, further comprising:
transmitting an acknowledgment message for the at least one received tile.

13. The method of claim 12, wherein the transmitting is based on a control bit encoded in the at least one tile.

14. An apparatus comprising:
a processor and an associated memory, the processor configured to,
receive at least one tile of a current frame of video data;
determine whether the tile is a static tile or a dynamic tile based on the current frame and a corresponding tile in an earlier frame;
partition pixels of a static tile into at least one bin, the number of bins being greater than the number of color values that were permitted for the corresponding tile in the earlier frame, the static tile being a tile that has not changed from the earlier frame; and
partition pixels of a changed tile into at least one bin, the number of bins being less than the number of color values that were permitted for the corresponding tile in the earlier frame, the changed tile being a tile that has changed from the earlier frame.

15. The apparatus of claim 14, wherein the processor is further configured to:
generate an encoded tile for the tile if the tile is a changed tile for which the number of color values is above a minimum threshold; and
generate an encoded tile for the tile if the tile is a static tile for which the number of color values is below a maximum threshold.

16. The apparatus of claim 15, wherein the processor is further configured to:
generate an encoded tile for the tile if an acknowledgment indication has not been received within a time duration after transmission of the tile for the corresponding tile in the earlier frame.

17. The apparatus of claim 15, wherein the encoded tile includes
a color table including color values for each color of the encoded tile, and
a pixel table containing the pixel values of the plurality of pixels of the encoded tile, the pixel values being indices into the color table.

18. The apparatus of claim 17, wherein the pixel values are encoded within the pixel table such that least-significant bits of the pixel values for each of the plurality of pixels are encoded in first data words in the pixel table and more-significant bits of the pixel values for each of the plurality of pixels are encoded in second data words.

19. The apparatus of claim 14, wherein the processor is further configured to:
determine a mean color value for the at least one bin;
generate a color table of the pixels of the tile by populating the table with the mean colors of the corresponding bin; and
determine a color index for each pixel of the tile, the color index being an index into the generated color table at which location the mean color of the corresponding bin is stored.

20. The apparatus of claim 19, wherein the partitioning separates the pixels into at least two bins.

21. The apparatus of claim 19, wherein the partitioning separates the pixels into one bin.

22. The apparatus of claim 19, wherein the processor is further configured to:
in a subsequent frame,
determine that the tile is a static tile;
separate the pixels of the static tile into a greater number of bins relative to a number of bins for the static tile in the previous frame.

23. The apparatus of claim 19, wherein the processor is further configured to:
in a subsequent frame,
determine that the tile is a dynamic tile;
separate the pixels of the dynamic tile into a fewer number of bins relative to a number of bins for the dynamic tile in the previous frame.

24. An apparatus comprising:
a processor and an associated memory, the processor configured to,
receive at least one tile, the at least one tile corresponding to a plurality of pixels of a frame of video data, the tile including a color table and a table of pixel values for the pixels of the tile, the pixel values being indexes into the color table, and the pixel values encoded such that least-significant bits of the pixel values for the plurality of pixels are encoded in the first data words and the more-significant bits of the pixel values of the plurality of pixels are encoded in second data words; and
construct at least one frame of the video data based on positional information encoded in the received at least one encoded tile.

25. The apparatus of claim 24, wherein the processor is further configured to:
transmit an acknowledgment message for the at least one received tile.

26. The apparatus of claim 25, wherein the processor transmits the acknowledgment message based on a control bit encoded in the at least one tile.
